(19) United States
(12) Patent Application Publication
(10) Pub. No.: US 2015/0213402 A1
(43) Pub. Date: Jul. 30, 2015

(54) LOGISTICS MANAGEMENT SYSTEM AND METHODS OF OPERATING THE SAME

(71) Applicants: Clayton Stroner, Chicago, IL (US); Michael Ward, Chicago, IL (US); Bill Driegert, Mercer Island, WA (US); Colby Friedeman, Chicago, IL (US); Mario Paluzzi, Chicago, IL (US); Christopher Wallace, Evanston, IL (US)

(72) Inventors: Clayton Stroner, Chicago, IL (US); Michael Ward, Chicago, IL (US); Bill Driegert, Mercer Island, WA (US); Colby Friedeman, Chicago, IL (US); Mario Paluzzi, Chicago, IL (US); Christopher Wallace, Evanston, IL (US)

(21) Appl. No.: 14/605,328

(22) Filed: Jan. 26, 2015

Related U.S. Application Data
(60) Provisional application No. 61/932,433, filed on Jan. 28, 2014.

(51) Int. Cl. G06Q 10/08; G06Q 30/04; G06Q 20/40

(52) U.S. Cl. CPC G06Q 10/0835; G06Q 20/405; G06Q 30/04

(57) ABSTRACT

An advance payment system having a processor, a memory and a load management unit performing the steps of receiving a request for an advanced payment for a load from a carrier, receiving information from the carrier relating to the load, determining if the information satisfies the advanced payment rules for the load, generating an identification code if the information satisfies the advanced payment rules for the load, assigning an expiration time to the identification code, and disabling the identification code when the expiration time has elapsed.

### RELATED APPLICATIONS

This application is a non-provisional application that claims the benefit of and the priority from U.S. Provisional Application No. 61/932,433 filed Jan. 28, 2014, titled “LOGISTICS MANAGEMENT SYSTEM AND METHODS OF OPERATING THE SAME”.

### BACKGROUND OF THE INVENTION

Logistics is the science and practice of managing complex flows of materials, people, and information across a physical network of production, distribution, and retail facilities. The logistics industry generates revenues through the transportation, reconfiguring, and storage of goods throughout the network, as well as from the software and information required to coordinate each step. Modern logistics networks operate with complex software systems used to optimize and simulate the network to minimize total cost and resource utilization.

Transportation logistics achieves costs savings and efficiency through the minimization of deadhead freight, miles in which a truck is traveling with an empty trailer. Individual shippers rarely have freight traveling both directions on a route, so eliminating deadhead requires coordination among multiple shippers and carriers. In practice, this coordination is still a highly manual process, requiring numerous phone calls between shippers and carriers, with a third party often intermediating. A need exists for a system that will allow logistic companies to receive requests for shipments and allow truckers to accept delivery of the shipments in real time, without manual intervention.

### SUMMARY OF THE INVENTION

One embodiment of the present invention includes an advance payment system having a processor, a memory and a load management unit performing the steps of receiving a request for an advanced payment for a load from a carrier, receiving information from the carrier relating to the load, determining if the information satisfies the advanced payment rules for the load, generating an identification code if the information satisfies the advanced payment rules for the load, assigning an expiration time to the identification code, and disabling the identification code when the expiration time has elapsed.

In another embodiment, the information includes shipping and receiving documents.

In another embodiment, the step of determining if the information satisfies the advanced payment rules for the load includes the step of determining if the information satisfies the advanced payment rules for the load includes the step of analyzing the information.

In another embodiment, the load management unit performs the steps of identifying missing information from the received information and notifying the carrier of the missing information.

In another embodiment, the load management unit performs the step of receiving an amount for the advanced payment from the carrier.

In another embodiment, the step of determining whether the requested amount for the advanced payment is greater than a predetermined amount associated with the load.

In another embodiment, the load management unit performs the step of notifying the carrier that the requested amount is greater than the predetermined amount.

In another embodiment, the load management unit performs the steps of transferring the requested amount to the carrier when the identification code is received before the expiration period has elapsed.

In another embodiment, the information for the load includes an authorization for advanced payments.

In another embodiment, the identification code is not generated if the information for the load does not include an authorization.

Another embodiment of the present invention includes an automatic invoicing system including a processor, a memory and a load management unit, the load management unit performing the steps of retrieving a plurality of invoicing rules associated with the load, receiving a plurality of documents from a carrier that are related to a load, identifying the contents of each document, comparing the contents of each document with the retrieved rules to determine whether all aspects of the rule have been satisfied, requesting additional information related to at least one missing aspect from the carrier, and generating an invoice for the load when all aspects of the rule have been satisfied.

In another embodiment, the invoicing rule includes a listing of documents related to the load.

In another embodiment, the load management unit performs the steps of transmitting the generated invoice to a distributor for payment.

In another embodiment, the load management unit performs the step of transferring funds from the distributor to the carrier.

In another embodiment, the load management unit performs the step of rejecting a document if it does not meet at least one requirement of the rule associated with the load.

In another embodiment, the load management unit performs the step of notifying the carrier that the document has been rejected.

In another embodiment, the notification includes information on the cause of the rejection.

In another embodiment, at least one of the documents is a bill of lading.

In another embodiment, the listing of documents is provided by a distributor associated with the load.

In another embodiment, the load management unit performs the step of notifying the carrier that a payment has been transferred.

### BRIEF DESCRIPTION OF THE DRAWING

Details of the present invention, including non-limiting benefits and advantages, will become more readily apparent to those of ordinary skill in the relevant art after reviewing the following detailed description and accompanying drawings, wherein:

FIG. 1 depicts a block diagram of an dynamic load routing system suitable for use with the methods and systems consistent with the present invention;

FIG. 2 depicts a more detailed depiction of the computer;

FIG. 3 shows a more detailed depiction of the computers;

FIG. 4 depicts an illustrative example of the operation of the dynamic load routing system;

FIG. 5 depicts a schematic representation of the load acceptance unit automatically accepting a load request from a supplier;

FIG. 6 depicts a schematic representation of the carrier analysis unit processing a load for each carrier;

FIG. 7 depicts a schematic representation of the carrier analysis unit scoring a load against a carrier;

FIG. 8A depicts a schematic representation of an automatic invoicing process;

FIG. 8B depicts one embodiment a user interface used by the load management unit to present the document requirements to a user;

FIG. 8C depicts one embodiment of a user interface used by the load management unit to present invoice information; and

FIG. 9 depicts one embodiment of a fuel advance request process.

### DETAILED DESCRIPTION OF THE INVENTION

While various embodiments of the present invention are described herein, it will be apparent to those of skill in the art that many more embodiments and implementations are possible that are within the scope of this invention. Accordingly, the present invention is not to be restricted except in light of the attached claims and their equivalents.

Described herein is a system for tendering freight to carriers by analyzing historical information on trucking lanes and carriers to determine which carriers are best suited to accept a shipping load. The system receives a request to haul a load from a shipper, matches the load with the appropriate carrier and presents the load for acceptance or rejection by the shipper. The system analyzes information pertaining to the load and a list of potential carriers to determine which carrier is best suited to haul the load.

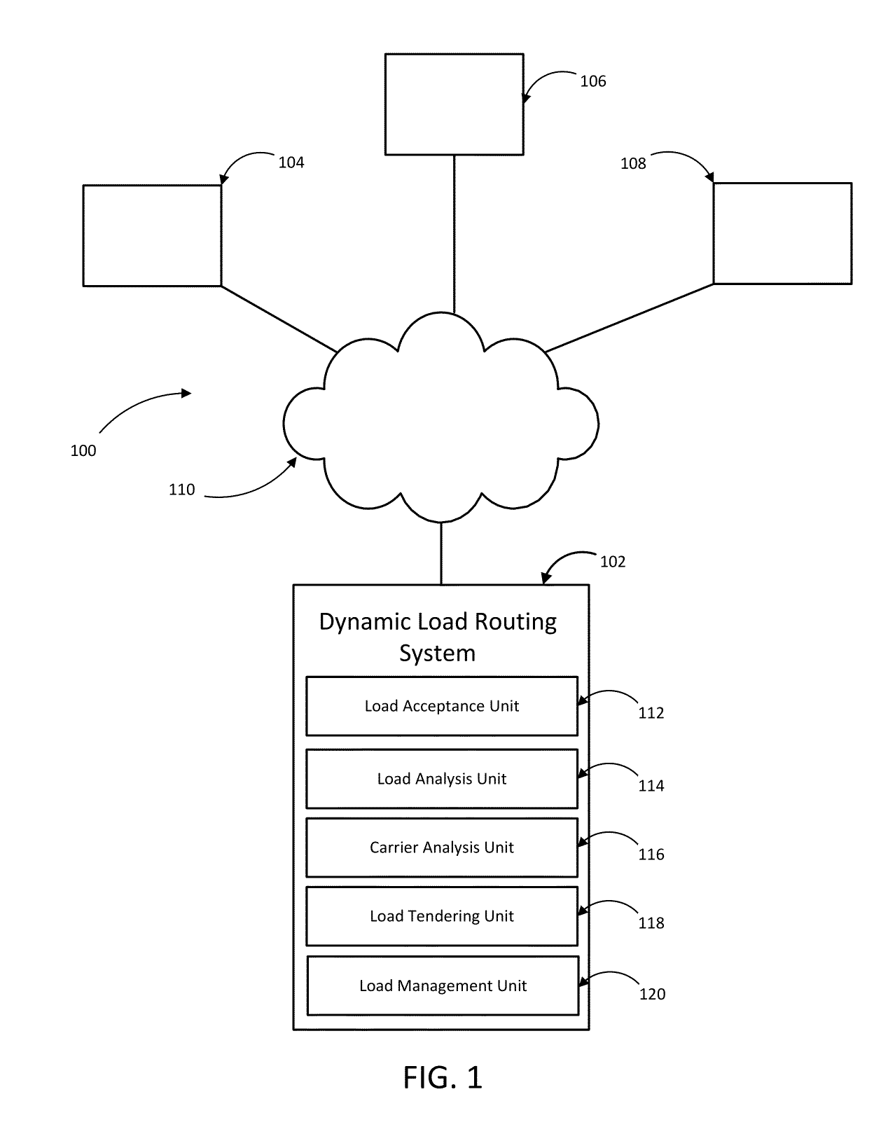

FIG. 1 depicts a block diagram of an dynamic load routing system 100 suitable for use with the methods and systems consistent with the present invention. The dynamic load routing system 100 comprises a plurality of computers 102, 104, 106 and 108 connected via a network 110. The network 108 is of a type that is suitable for connecting the computers for communication, such as a circuit-switched network or a packet switched network. Also, the network 110 may include a number of different networks, such as a local area network, a wide area network such as the Internet, telephone networks including telephone networks with dedicated communication links, connection-less network, and wireless networks. In the illustrative example shown in FIG. 1, the network 110 is the Internet. Each of the computers 102, 104, 106 and 108 shown in FIG. 1 is connected to the network 110 via a suitable communication link, such as a dedicated communication line or a wireless communication link.

In an illustrative example, computer 102 serves as a dynamic load routing unit that includes a load acceptance unit 112, a load analysis unit 114, a carrier analysis unit 116, a load tendering unit 118, and a load management unit 120. The number of computers and the network configuration shown in FIG. 1 are merely an illustrative example. One having skill in the art will appreciate that the dynamic pricing system 100 may include a different number of computers and networks. For example, computer 102 may include the load acceptance unit 112 as well as one or more of the load analysis unit 114 and load management unit 120. Further, the load tendering unit 118 and carrier analysis unit 116 may reside on a different computer than computer 102.

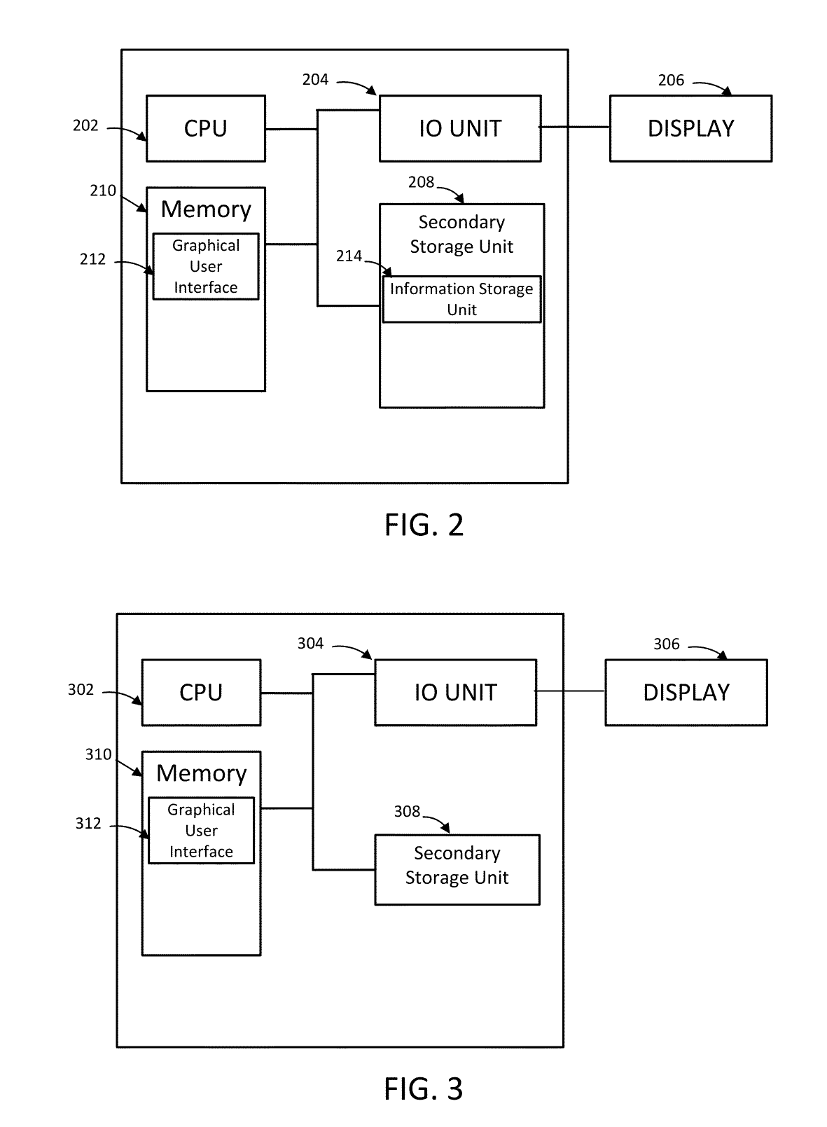

FIG. 2 depicts a more detailed depiction of the computer 102. The computer 102 comprises a central processing unit (CPU) 202, an input output (IO) unit 204, a display device 206 communicatively coupled to the IO Unit 204, a secondary storage device 208, and a memory 210. The computer 202 may further comprise standard input devices such as a keyboard, a mouse, a digitizer, or a speech processing means (each not illustrated).

The computer 102's memory 210 includes a Graphical User Interface (“GUI”) 212 which is used to gather information from a user via the display device 206 and I/O unit 204 as described herein. The GUI 212 includes any user interface capable of being displayed on a display device 206 including, but not limited to, a web page, a display panel in an executable program, or any other interface capable of being displayed on a computer screen. The GUI 212 may also be stored in the secondary storage unit 208. In one embodiment consistent with the present invention, the GUI 212 is displayed using commercially available hypertext markup language (“HTML”) viewing software such as, but not limited to, Microsoft Internet Explorer, Google Chrome or any other commercially available HTML viewing software. The secondary storage unit 208 may include an information storage unit 214. The information storage unit may be a rational database such as, but not including Microsoft's SQL, Oracle or any other database.

FIG. 3 shows a more detailed depiction of the computers 104, 106 and 108. Each computer 104, 106 and 108 comprises a central processing unit (CPU) 302, an input output (I/O) unit 304, a display device 306 communicatively coupled to the IO Unit 304, a secondary storage device 308, and a memory 310. Each computer 104, 106 and 108 may further comprise standard input devices such as a keyboard, a mouse, a digitizer, or a speech processing means (each not illustrated).

Each computer 104, 106 and 108's memory 310 includes a GUI 312 which is used to gather information from a user via the display device 306 and I/O unit 304 as described herein. The GUI 312 includes any user interface capable of being displayed on a display device 306 including, but not limited to, a web page, a display panel in an executable program, or any other interface capable of being displayed on a computer screen. The GUI 312 may also be stored in the secondary storage unit 208. In one embodiment consistent with the present invention, the GUI 312 is displayed using commercially available hypertext markup language (“HTML”) viewing software such as, but not limited to, Microsoft Internet Explorer, Google Chrome or any other commercially available HTML viewing software.

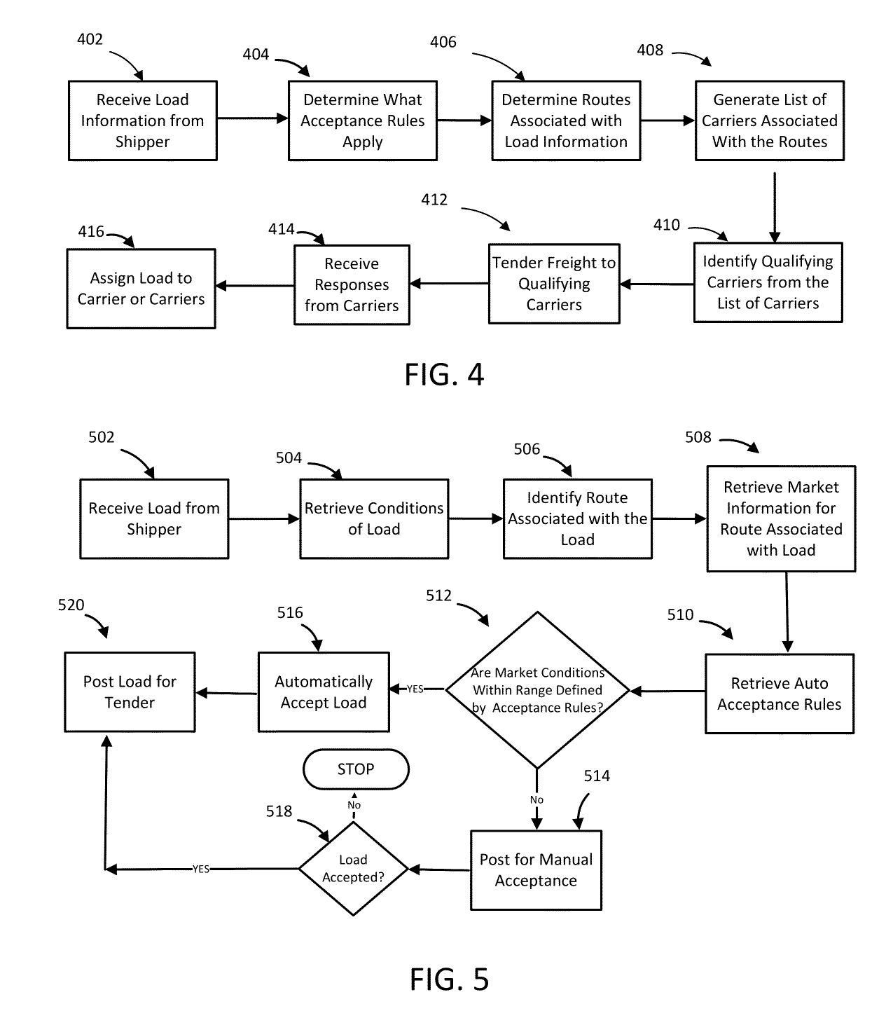

FIG. 4 depicts an illustrative example of the operation of the dynamic load routing system 100. In step 402, the load acceptance unit 112 receives a load shipping request from a supplier. The load acceptance unit 112 may receive the load shipping request electronically via a web site, e-mail or by any other means. The load information may include, but is not limited to, the origin of the load, the destination of the load, a special load designation such as hazardous material or refrigerated loads, the date and time of pick-up and delivery, and the equipment type required to haul the load. In step 404, the load acceptance unit 112 determines what load acceptance rules apply to the shipper. The load acceptance rules define a listing of conditions required for the logistics entity to accept a load. If the shipper and shipment satisfy the load acceptance rules, the load is accepted by the logistics entity. If the rules are not satisfied, the load is not accepted by the logistics entity.

In step 406, if the load is accepted, the load analysis unit 114 analyzes the load information and determines the routes, or lanes, associated with the load. In step 408, the carrier analysis unit 116 generates a list of potential carriers based on the load information and on carrier information stored in the information storage unit 214 for each carrier. Each carrier may designate specific lanes where they would like notifications of available loads. The carrier may designate the preferred lanes by identifying a city, state, zip code or region for the origin of a load, the city, state, zip code or region of the destination for the destination of the load and the type of equipment required to haul the load. When a load is tendered that meets the origin, destination and equipment criteria entered by the carrier, the carrier is selected as a potential carrier.

In step 410, the carrier analysis unit 116 compares the characteristics of the load with the carrier information in the information storage unit 214 to generate a listing of preferred carriers for the load. The carrier analysis unit 116 may apply a score to each carrier based on the carrier information to determine which carriers of the list of carriers is best suited to accept the tendered load. The carrier information analyzed by the carrier analysis unit 116 to determine the list of preferred carriers may be based on information stored in the information storage unit 214 including, but not limited to, the preferred lane preferences for each carrier, the carrier's customer preferences, the facility preferences, meaning the facility where the load originates or where the load must be delivered, the commodity preferences of the carrier, the freight profile preferences of the carrier such as weight or size limitations, and licensing exclusions such as alcohol, hazmat and TWIC.

In step 412, the load tendering unit 118 may tender the load to each or all of the preferred carriers. A load may be tendered to a carrier in multiple ways including, but not limited to sending a notification where a carrier is notified that a load matching their criteria is available. If a notification is sent, the carrier has no option to automatically accept or submit a bid. Further, the carrier must solicit an offer from the logistic management company that accepted the load. The system 100 may also transmit an accept or reject message to the carrier where the carrier is given the option to accept or reject the load at a fixed rate. The system 100 may also transmit an accept, reject, or make an offer request to the carrier where the carrier may have run a similar lane previously but the prior rate is not presumed to be contracted for all future matching shipments. In this instance, the carrier may accept the load at the previous rate, or make a higher offer depending on market conditions. The system may also transmit a make offer or reject request where a carrier may have run a lane that was largely similar to the present shipment, but the carrier has no active rate on the exact shipment offered. This option allows the carrier to make an offer or reject the load.

The load tendering unit 118 may tender the load to multiple carriers simultaneously with each carrier having the ability to accept the load over a predetermined period of time. In one embodiment, the predetermined period of time for each carrier is different. In another embodiment, the predetermined period of time for one carrier may overlap with the predetermined period of time of another carrier. In another embodiment, each carrier receives different notifications. As an illustrative example, one carrier may receive a notification that a load is available, another carrier may simultaneously receive a request to accept or reject the load, and another carrier may simultaneously receive a notification requesting the carrier make an offer to carry the load.

In step 414, the load management unit 120 receives responses from the carriers tendered the load. The responses may be configured based on the type of notification transmitted to each carrier. Carriers may manually or automatically accept tendered loads based on the configuration of the carrier in the dynamic load routing unit 102. A carrier may configure specific characteristics of a load that will allow the load to be accepted without review by the carrier as will be discussed herein. In step 416, the load is assigned to the accepting carrier and the pickup and delivery of the load is coordinated by the logistics entity.

FIG. 5 depicts a schematic representation of the load acceptance unit 112 automatically accepting a load request from a supplier. In step 502, a load request is received from a supplier by the load acceptance unit 112. In step 504, the load analysis unit 114 retrieves the conditions of the load. The conditions may include, but are not limited to, the origin and destination of the load, the load commodity, the type of equipment required to haul the load, the required pickup and delivery dates for the load, and any other information pertaining to the load. In step 506, the load analysis unit 112 identifies the route or lane associated with the load.

In step 508, the load analysis unit 114 retrieves market information on the route associated with the load. The market information may include current rates to haul similar loads along the identified routes, current offers to haul similar loads along the route, or fixed rates from carriers to haul similar loads along the route. In step 510, the load analysis unit 114 retrieves the auto acceptance rules for the supplier from the information storage unit 214. The auto acceptance rules are rules established by the logistics entity listing conditions that must be satisfied for the load acceptance unit 112 to automatically accept a load offered by a supplier. Acceptance rules may be linked to specific rate quotes stored in the information storage unit 214. Each rate quote has a specific point to point lane defined and is filtered by mode, equipment requirements, and commodity restrictions. Each rate quote also has a defined start date and only one rate quote may be active for each supplier. Load requests are compared to a rate quote stored in the information storage unit 214 for the lane associated with the load request before being compared to the acceptance rules.

In step 512, the load acceptance unit 112 compares the market information to the required market conditions detailed in the retrieved auto acceptance rules. In step 514, if the market conditions are not within the market conditions listed in the auto acceptance rule, the load is placed into a queue for manual acceptance. In step 516, if the market conditions satisfy the market conditions listed in the auto acceptance rule, the load is automatically accepted by the load acceptance unit 112. The load acceptance unit 112 may accept a load by sending a confirmation of acceptance message, such as an e-mail, to the supplier. In step 518, if the load is manually accepted it is posted for tender. If the load is not accepted the process stops.

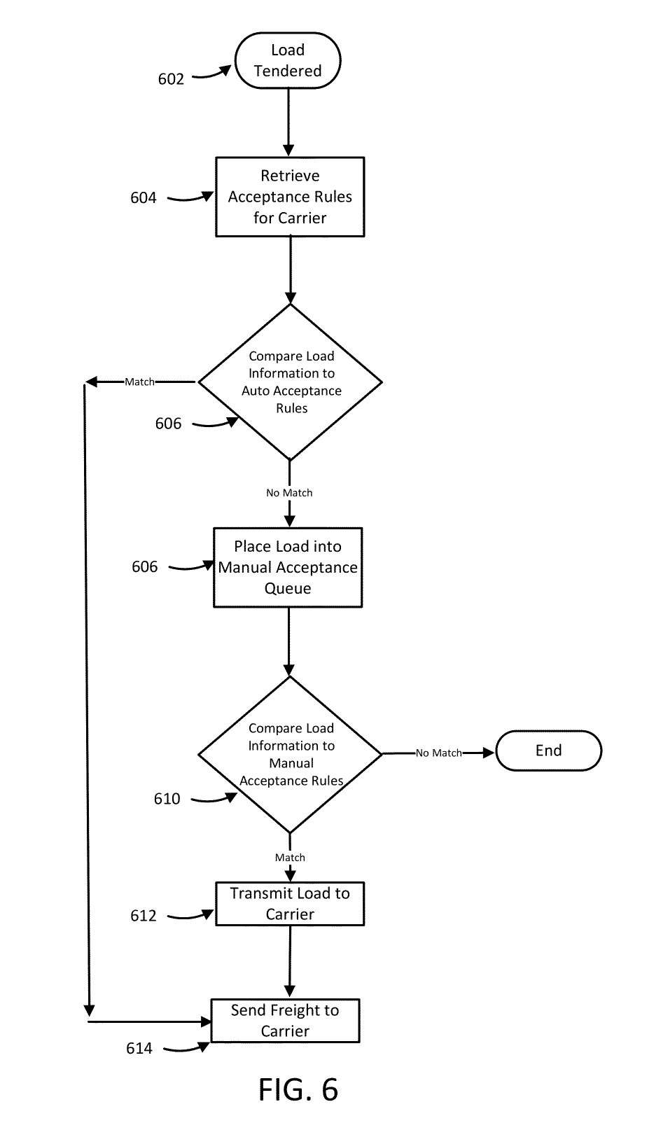

FIG. 6 depicts a schematic representation of the carrier analysis unit 116 processing a load for each carrier. In step 602, a load is tendered to a carrier using any of the methods for tendering a load previously described. In step 604, the carrier analysis unit 116 retrieves the acceptance rules for each identified carrier. The acceptance rules include conditions pertaining to the supplier, load, lane and commodity that have been preapproved by the carrier to allow the load tendering unit 118 or load management unit 120 to automatically accept the load for the carrier. In step 606, the carrier analysis unit 116 compares the information on the tendered freight with the acceptance conditions established by the carrier. If the load conditions are substantially similar to the established conditions for acceptance by the carrier, the carrier analysis unit 116 notifies the load tendering unit 118 to accept the load for the carrier. In step 608, if the load conditions are not substantially similar to the acceptance conditions, the load is placed into a queue for manual acceptance by the carrier.

In step 610, the load tendering unit gathers acceptance criteria for the load from the carrier and compares the conditions of the load with the manually gathered acceptance criteria. In step 612, if the manually gathered acceptance criteria is substantially similar to the load characteristics, the carrier analysis unit 116 accepts the load for the carrier. In step 614, the load information is transmitted to the carrier and the load is marked as accepted in the dynamic routing unit 102. The carrier analysis unit 116 may log the characteristics of each load manually accepted by the carrier and notify the carrier of future loads that can be automatically accepted or load types that can be configured for automatic acceptance.

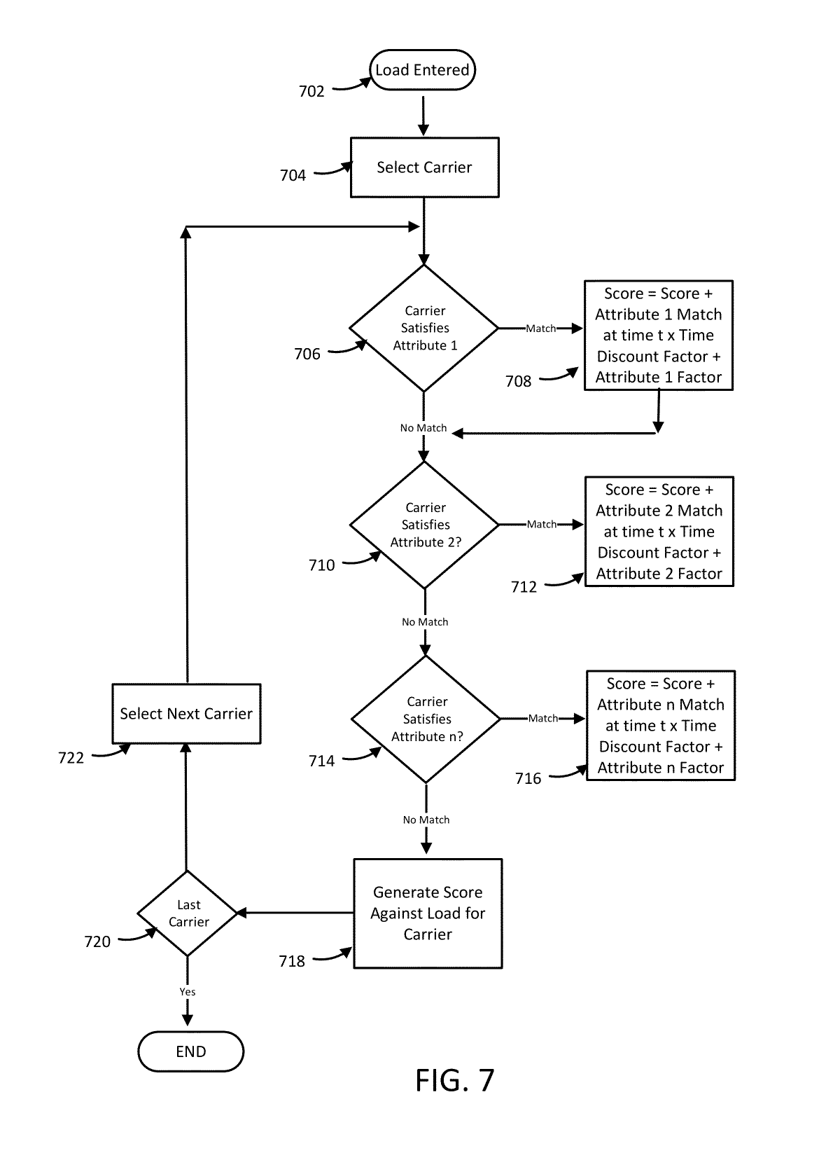

FIG. 7 depicts a schematic representation of the carrier analysis unit scoring a load against a carrier. In step 702, a first carrier is selected from a list of carriers stored in the information storage unit 214. In step 704, the carrier analysis unit 116 determines whether the carrier satisfies a first attribute or a plurality of attributes. The plurality of attributes can include, but is not limited to, information on previous activity by the carrier including whether the carrier has hauled a load along the same lane and mode, whether the carrier has posted available capacity on a similar lane, whether the carrier has posted a lane preference for a similar lane, whether the carrier has posted capacity at the load origin, whether the carrier has posted capacity at the load destination, the proximity of the carrier to the load destination, or the proximity of the carrier to the load origin. In step 708, if the carrier information matches the first attribute, the carrier analysis unit 116 calculates a score for the first attribute. The score may be the total score of the carrier for the load plus a value representing the quality of the match of the carrier to the load plus a time discount factor where newer information is given a larger weight than older information plus an adjustment factor for the attribute representing the overall relevancy of the attribute to the load.

If there is no match, or after the score is calculated for the previous attribute, the process moves to step 710 where a second attribute is compared to the carrier information. If there is no match for a specific attribute, the score for that attribute is zero. In step 712, a score for attribute 2 is calculated and is added to the overall score for the carrier. In step 714, the process continues until all attributes are compared and in step 716 the remaining attributes are scored In step 718, an overall score for the carrier in relation to the load is calculated. In step 720, the carrier analysis unit 116 determines whether all carriers have been scored. In step 722, if all carriers have not been scored, a new carrier is selected and the process returns to step 706 where the next carrier is scored.

After all carriers are scored for a load, the carrier analysis unit 116 determines which carriers have the highest scores for the load, and includes those carriers in the preferred carrier group. During the scoring, the carrier analysis unit 116 retrieves different attribute factors from the information storage unit 214. When the load is accepted by the logistics entity, each of the attributes and associated weighing factors are determined by the supplier or by the logistics entity. When the load is prepared for tendering, the carrier analysis unit 116 retrieves the attributes and weighing factors and determines the score for each carrier.

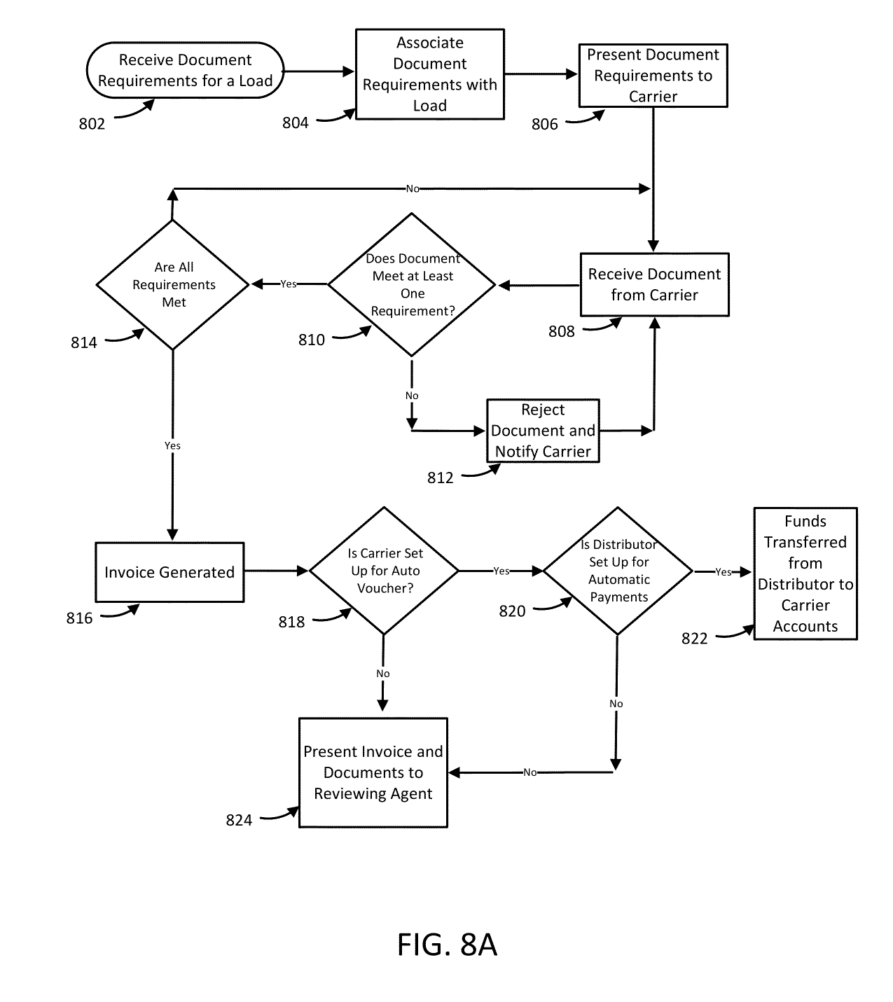

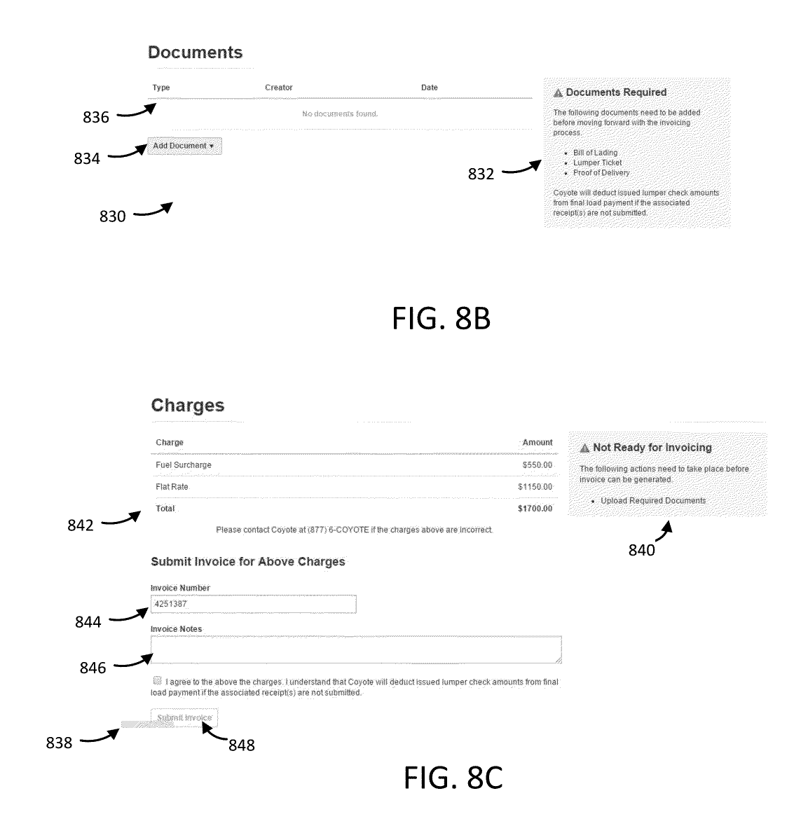

FIG. 8A depicts a schematic representation of an automatic invoicing process. In step 802, the load management unit 120 receives document requirements from a supplier associated with a specific load. The document requirements may include specific forms or documents that are required from a carrier to initiate an automatic payment. In one embodiment, the documents are forms previously provided to the carrier. In step 804, the load management unit 120 associates the document requirements with the individual load. In step 806, the load management unit 120 presents the load requirements to a user. FIG. 8B depicts one embodiment a user interface 830 used by the load management unit 120 to present the document requirements to a user. The user interface includes a document status portion 832 that displays the documents required by the supplier to initiate a payment. In one embodiment, the document status portion 832 changes color based on the documents uploaded.

In step 808, the load management unit 120 receives a document from the carrier. The document may be uploaded by the carrier using the user interface 832. To upload the document, the carrier selects the document from a memory location on a computer. The carrier then selects the document type from a list of documents types presented to the user. In one embodiment, the document types may correspond to the documents required by the user. In one embodiment, the document types displayed to the user are limited to the document types of the document requirements for the load selected by the user. The document is uploaded to the load management unit 120 after an unload confirmation command is received via the upload confirmation button 834. In step 810, the load management unit 120 determines if the uploaded document satisfies at least one requirement of the document requirements. In one embodiment, the uploaded document is a predefined form having specific words or symbols to identify the contents of the form. As an illustrative example, the form may include areas where the carrier electronically enters information from a bill of lading that is one of the required documents for the load. The load management unit 120 may determine if the information from the bill of lading is correctly entered into the form, and may compare the contents of the form to the actual bill of lading or to expected values for the bill of lading to determine whether the form is valid. If a predetermined number of fields in the form substantially match the expected values, the document is confirmed to meet at least one requirement.

In step 812, if the document does not meet at least one requirement, the load management unit 120 notifies the user of the error and waits to receive a new document. The document may be rejected if at least one requirement if information is excluded, the wrong form is uploaded under the wrong category, or for any other reason determined by the load management unit 120. In step 814, the load management unit 120 determines if all the document requirements of the load have been met. All the document requirements have been met when all the documents and information are uploaded by the carrier. If all the document requirements are not met, the load management unit 120 waits for the next document to load. In one embodiment, the load management unit 120 displays the current listing of uploaded documents in the document status portion 836 of the user interface. In one embodiment, if all the documents are uploaded, the document status portion 832 of the user interface may turn green.

In step 816, after all required documents have been uploaded and confirmed, the load management unit 120 generates an invoice for the delivery of the load and associates the invoice with the carrier, supplier and load. The invoice includes a price to be paid to the carrier, the supplier associated with the load, information on the load and information on the carrier. In one embodiment, the price is reduced by any prepayments to the carrier. FIG. 8C depicts one embodiment a user interface 838 used by the load management unit 120 to present invoice information to a carrier. The user interface 838 includes an invoice status portion 840 displaying the status of the invoice submission, an invoice detail portion 842 showing payment information on the invoice, an invoice number portion 844 displaying the current invoice number associated with the load, a notes portion 846 and an invoice submission unit 848. The payment information may be the payment information related to the load, or may be the payment information extracted from the uploaded documents. In one embodiment, the invoice status portion 840 changes colors based on the status of the invoice. In one embodiment, the invoice number is associated with the load when the load is created. The invoice may be submitted by receiving a submission command from the invoice submission unit 848. When the invoice is submitted, the load management unit 120 marks the invoice as being submitted and accepted by the carrier.

In step 818, the load management unit 120 determines if the carrier is enabled for automatic payment for carrying the load. In step 824, if the carrier is not enabled for automatic payment, the load management unit 120 transmits the load and document information to a manager for visual inspection and payment. In step 820, if the carrier is enabled for automatic payment, the load management unit 120 determines if the supplier is enabled for automatic payment. If the supplier is not enabled for automatic payment, the load information, carrier information, and document information are transmitted to a manager for visual inspection and confirmation. In step 822, if the supplier and carrier are enabled for automatic payment, the load management unit 120 transfers funds from the supplier account to the carrier account in the amount stored in the invoice and associated with the load. In one embodiment, a notification is sent to the carrier notifying them that a payment has been made to their account.

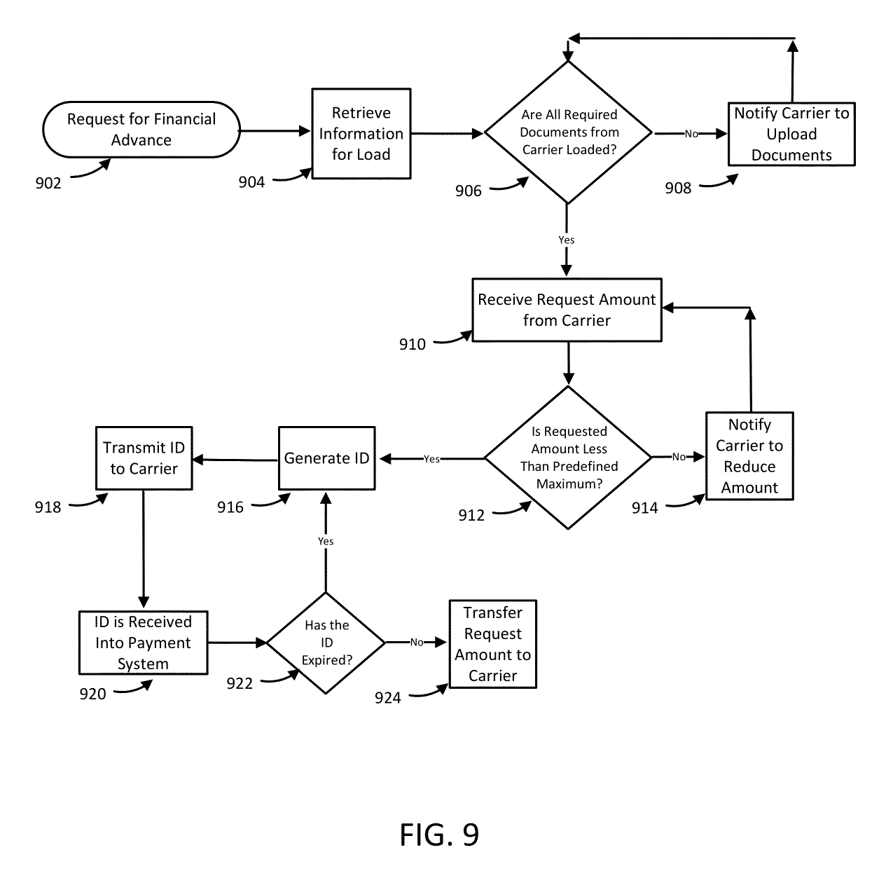

FIG. 9 depicts one embodiment of a financial advance request process. The financial advance may be a financial advance for a specific purpose such as, but not limited to, purchasing fuel, lumper advances, mechanical advances or any other purpose. In step 902, a request for a monetary advance associated with a specific load is received by the load management unit 120. In step 904, the load management unit 120 retrieves information on the load. The information may include an indication of whether a financial advance has been authorized for the load, the maximum amount of the financial advance or any other related information on the load. In step 906, the load management unit 120 determines if all required documents related to the financial advance have been uploaded. The required documents may include, but are not limited to, the bill of lading for the load. The required documents may be identified by the supplier and associated with the load. In step 908, if the required documents have not been uploaded, the load management unit 120 notifies the carrier that the required documents have not be loaded. In step 910, if all the required documents for a financial advance has been uploaded, the load management unit 120 receives the requested amount of the financial advance from the carrier.

In step 912, the load management unit 120 determines if the requested amount is less than a predefined maximum amount. In step 914, if the requested amount is more than the predetermined amount, the load management unit 120 notifies the carrier that the requested amount is greater than the maximum amount and requests a new amount be requested. In step 916, if the requested amount is less than the predetermined maximum amount, the load management unit 120 generates an identification code associated with the financial advance for the load. The identification code may be any unique identifier that will allow the carrier to confirm their identity. The load management unit 120 will also associate an expiration date and time with the identification code when it is generated. In one embodiment, the identification code expires a set number of hours after date and time the identification code was generated. In another embodiment, the identification code expires a set number of hours after the request for the financial advance was submitted. In one embodiment, the identification code expiration time is 48 hours after the time the identification code was issued.

In step 918, the identification code is transferred to the carrier along with the expiration date and time of the identification code. The identification code may be transferred using any known methods of transferring a pin including, but not limited to, a SMS message, an E-mail, telephonically, or by any other known method. In step 920, the identification code is received by the load management unit 120. The load management unit 120 retrieves the information associated with the identification code along with the issue date and expiration date of the identification code. In step 922, the load management unit 120 determines if the identification code has expired. If the identification code has expired, a new identification code is generated and transmitted to the carrier with a message notifying the carrier that the old identification code has expired and cannot be used. In step 924, if the identification code has not expired, the load management unit 120 transmits funds from the supplier to the carrier in the amount requested.

In the present disclosure, the words “a” or “an” are to be taken to include both the singular and the plural. Conversely, any reference to plural items shall, where appropriate, include the singular.

It should be understood that various changes and modifications to the presently preferred embodiments disclosed herein will be apparent to those skilled in the art. Such changes and modifications can be made without departing from the spirit and scope of the present disclosure and without diminishing its intended advantages. It is therefore intended that such changes and modifications be covered by the appended claims.

1. An advance payment system having a processor, a memory and a load management unit performing the steps of:
receiving a request for an advanced payment for a load from a carrier;
receiving information from the carrier relating to the load;
determining if the information satisfies the advanced payment rules for the load;
generating an identification code if the information satisfies the advanced payment rules for the load;
assigning an expiration time to the identification code; and
disabling the identification code when the expiration time has elapsed.

2. The advance payment system of claim 1 wherein the information includes shipping and receiving documents.

3. The advanced payment system of claim 2 wherein the step of determining if the information satisfies the advanced payment rules for the load includes the step of determining if the information satisfies the advanced payment rules for the load includes the step of analyzing the information.

4. The advanced payment system of claim 1 wherein the load management unit performs the steps of
identifying missing information from the received information and notifying the carrier of the missing information.

5. The advanced payment system of claim 1 wherein the load management unit performs the step of receiving an amount for the advanced payment from the carrier.

6. The advanced payment system of claim 5 wherein the step of determining whether the requested amount for the advanced payment is greater than a predetermined amount associated with the load.

7. The advanced payment system of claim 6 wherein the load management unit performs the step of notifying the carrier that the requested amount is greater than the predetermined amount.

8. The advanced payment system of claim 1 wherein the load management unit performs the steps of transferring the requested amount to the carrier when the identification code is received before the expiration period has elapsed.

9. The advanced payment system of claim 1 wherein the information for the load includes an authorization for advanced payments.

10. The advanced payment system of claim 9 wherein the identification code is not generated if the information for the load does not include an authorization.

11. An automatic invoicing system including a processor, a memory and a load management unit, the load management unit performing the steps of:
retrieving a plurality of invoicing rules associated with the load;
receiving a plurality of documents from a carrier that are related to a load;
identifying the contents of each document;
comparing the contents of each document with the retrieved rules to determine whether all aspects of the rule have been satisfied;
requesting additional information related to at least one missing aspect from the carrier;
generating an invoice for the load when all aspects of the rule have been satisfied.

12. The automatic invoicing system of claim 11 wherein the invoicing rule includes a listing of documents related to the load.

13. The automatic invoicing system of claim 11 wherein the load management unit performs the steps of transmitting the generated invoice to a distributor for payment.

14. The automatic invoicing system of claim 13 wherein the load management unit performs the step of transferring funds from the distributor to the carrier.

15. The automatic invoicing system of claim 11 wherein the load management unit performs the step of rejecting a document if it does not meet at least one requirement of the rule associated with the load.

16. The automatic invoicing system of claim 15 wherein the load management unit performs the step of notifying the carrier that the document has been rejected.

17. The automatic invoicing system of claim 16 wherein the notification includes information on the cause of the rejection.

18. The automatic invoicing system of claim 11 wherein at least one of the documents is a bill of lading.

19. The automatic invoicing system of claim 11 wherein the listing of documents is provided by a distributor associated with the load.

20. The automatic invoicing system of claim 11 wherein the load management unit performs the step of notifying the carrier that a payment has been transferred.
